(19) United States
(12) Patent Application Publication
(10) Pub. No.: US 2026/0247017 A1
(43) Pub. Date: Aug. 20, 2026

(54) IMAGING DEVICE

(71) Applicant: Panasonic Intellectual Property Management Co., Ltd., Osaka (JP)

(72) Inventors: Eiji YAMAGUCHI, Osaka (JP); Jun SAIKI, Hyogo (JP); Takuya AMANO, Osaka (JP)

(73) Assignee: Panasonic Intellectual Property Management Co., Ltd., Osaka (JP)

(21) Appl. No.: 19/539,146

(22) Filed: Feb. 13, 2026

(30) Foreign Application Priority Data
Feb. 18, 2025 (JP) 2025-024323

(51) Int. Cl. H04N 23/55; H04N 23/52; H04N 23/667; H04N 23/68

(52) U.S. Cl. CPC H04N 23/55; H04N 23/52; H04N 23/667; H04N 23/68; H04N 23/6812

(57) ABSTRACT

An imaging device includes: a sensor unit; a front case that is a part of a housing and includes a sensor unit attachment portion; and a vibration control device that couples the sensor unit and the sensor unit attachment portion in a first direction. The sensor unit includes at least one sensor, and a base member that supports the sensor. A part of the base member overlaps the sensor unit attachment portion as viewed in a second direction intersecting the first direction.

### BACKGROUND

### Technical Field

The present disclosure relates to an imaging device.

### Description of the Related Art

Conventionally, there has been known an imaging device equipped with a gyro sensor unit in order to suppress image blur caused by vibration transmitted from a user's hand to a housing of the imaging device, such as the imaging device described in JP 2018-060160 A. The gyro sensor unit is used to calculate a displacement amount of the housing displaced by vibration transmitted from the user's hand to the housing of the imaging device. By shifting the imaging element in the housing by the shift amount that offsets the calculated displacement amount, a captured image in which image blur is suppressed is obtained.

In the case of the imaging device described in JP 2018-060160 A, the gyro sensor unit is mounted in a hand grip portion of a housing. Specifically, the gyro sensor unit is connected to the front case constituting the front portion of the housing via a vibration control device. The vibration control device includes a retainer member facing the front case at a constant interval in the front-rear direction of the imaging device with the gyro sensor unit present therebetween, a first vibration control member disposed between the front case and the gyro sensor unit, and a second vibration control member disposed between the gyro sensor unit and the retainer member. Such a vibration control device prevents vibrations (vibrations generated in the housing) other than vibrations transmitted from the user's hand to the housing from being transmitted to the gyro sensor unit. As a result, the displacement amount of the housing can be accurately calculated based on the detection result of the gyro sensor unit.

### SUMMARY

However, in the case of the imaging device described in JP 2018-060160 A, in the hand grip of the housing, the attachment portion of the front case to which the gyro sensor unit is attached, the first vibration control member, the gyro sensor unit, the second vibration control member, and the retainer member are arranged in this order in the front-rear direction of the imaging device. Therefore, it is difficult to make the size of the imaging device compact in the front-rear direction.

Therefore, an object of the present disclosure is to reduce an installation space of a sensor unit and a vibration control device in an imaging device in which the sensor unit is mounted via the vibration control device.

In order to solve the above problem, according to an aspect of the present disclosure, an imaging device is provided that includes:

a sensor unit;

a front case that is a part of a housing and includes a sensor unit attachment portion; and

a vibration control device that couples the sensor unit and the sensor unit attachment portion in a first direction, wherein

the sensor unit includes

at least one sensor, and

a base member that supports the sensor, and

a part of the base member overlaps the sensor unit attachment portion as viewed in a second direction intersecting the first direction.

According to the present disclosure, in an imaging device in which a sensor unit is mounted via a vibration control device, an installation space for the sensor unit and the vibration control device can be reduced.

### BRIEF DESCRIPTION OF DRAWINGS

FIG. 1 is a perspective view of an imaging device according to an embodiment of the present disclosure;

FIG. 2 is a left side view of the imaging device;

FIG. 3 is a front perspective view of a sensor unit;

FIG. 4 is a rear perspective view of the sensor unit;

FIG. 5 is an exploded perspective view of the sensor unit;

FIG. 6 is a cross-sectional view of a hand grip portion of the imaging device as viewed from above;

FIG. 7 is a cross-sectional view of the hand grip portion of the imaging device as viewed from the left;

FIG. 8 is an exploded perspective view of the hand grip portion of the imaging device;

FIG. 9 is a perspective view of the sensor unit attached to a front case;

FIG. 10 is a front view of the sensor unit attached to the front case;

FIG. 11 is a front view of a part of the front case; and

FIG. 12 is a perspective view illustrating attachment of the sensor unit to the front case.

### DETAILED DESCRIPTION

Hereinafter, embodiments will be described in detail with reference to the drawings as appropriate. However, unnecessarily detailed description may be omitted. For example, a detailed description of a well-known matter and a repeated description of substantially the same configuration may be omitted. This is to avoid unnecessary redundancy of the following description and to facilitate understanding of those skilled in the art.

In addition, the inventor(s) provides the accompanying drawings and the following description in order for those skilled in the art to fully understand the present disclosure, and it is not intended to limit the subject matter described in the claims by these.

Hereinafter, the imaging device according to the embodiment of the present disclosure will be described with reference to the drawings.

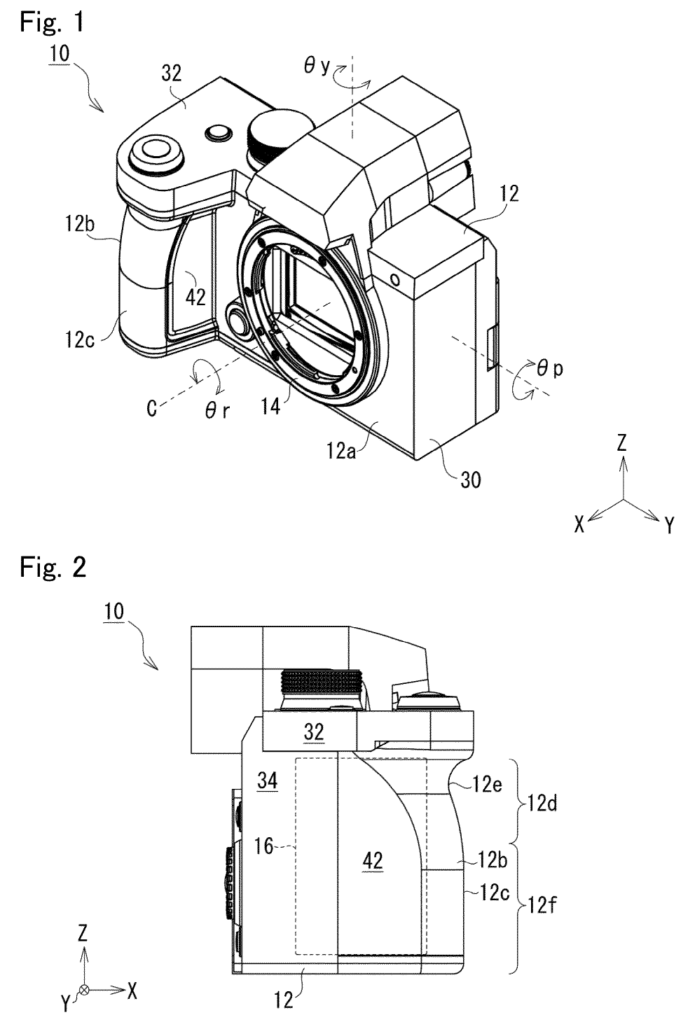

FIG. 1 is a perspective view of an imaging device according to an embodiment of the present disclosure. FIG. 2 is a left side view of the imaging device. Note that the X-Y-Z orthogonal coordinate system illustrated in the drawings is for facilitating understanding of the embodiment of the present disclosure, and does not limit the embodiment of the present disclosure. The X-axis direction is the front-rear direction of the imaging device, the Y-axis direction is the left-right direction, and the Z-axis direction is the up-down direction. Furthermore, in the present specification, the side of the imaging device on which the subject is present is referred to as a “front side” of the imaging device. In addition, a "left side" and a "right side" of the imaging device are a "left side" and a "right side" when the imaging device is viewed from the front, that is, when the imaging device is viewed from the subject side.

As illustrated in FIG. 1, an imaging device 10 according to the present embodiment is a so-called lens interchangeable digital camera, and includes a housing 12. A lens mount 14 to which a lens (not illustrated) is detachably attached is provided on a front surface 12a of the housing 12 facing the subject at the time of photographing. The front surface 12a is provided with a hand grip portion 12b that the user grips at the time of photographing.

Specifically, the hand grip portion 12b is a portion of the housing 12 that is provided on the left side of the lens mount 14 and protrudes forward in a front view (as viewed in the X-axis direction) of the imaging device 10. The hand grip portion 12b includes a hand grip surface 12c having a curved surface shape protruding in convex forward as viewed from above (as viewed in the Z-axis direction) of the imaging device 10. As shown in FIG. 2, as viewed in a left side view (as viewed in the Y-axis direction) of the imaging device 10, a recessed portion 12e recessed rearward of the housing 12 is provided in a portion of the upper portion 12d of the hand grip portion 12b corresponding to the hand grip surface 12c. At the time of normal photographing, the middle finger of the user's right hand is applied to the recessed portion 12e. In addition, the ring finger and the little finger of the user are applied to the portion of the hand grip surface 12c in a lower portion 12f of the hand grip portion 12b.

As shown in FIG. 2, in the present embodiment, a battery 16 is mounted inside the housing 12 behind the hand grip surface 12c of the hand grip portion 12b. A sensor unit is disposed in a space between the hand grip surface 12c and the battery 16.

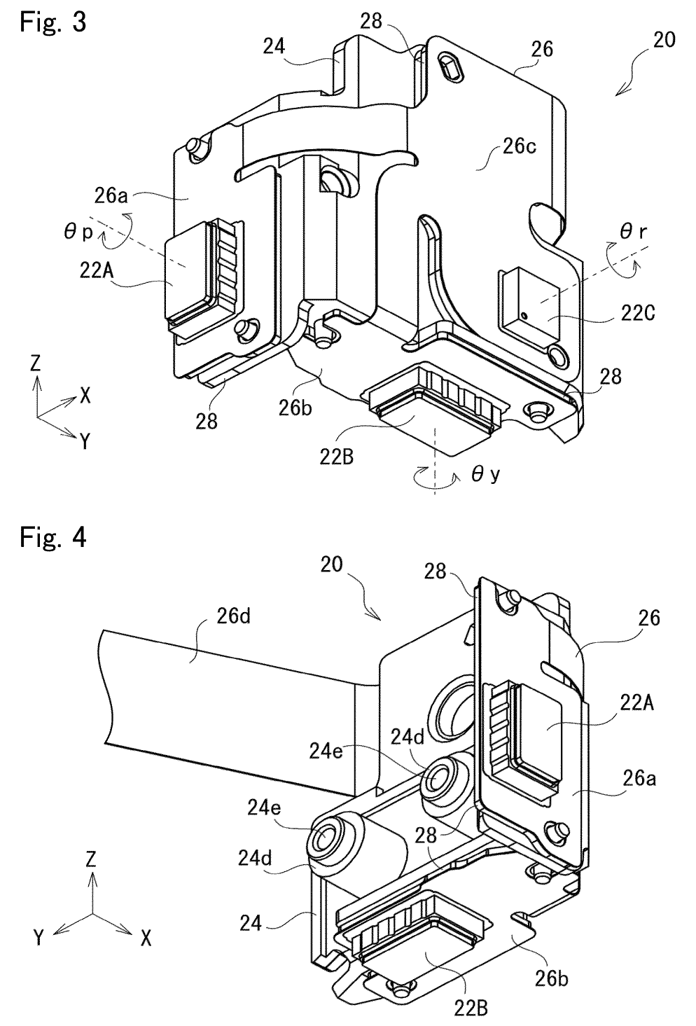

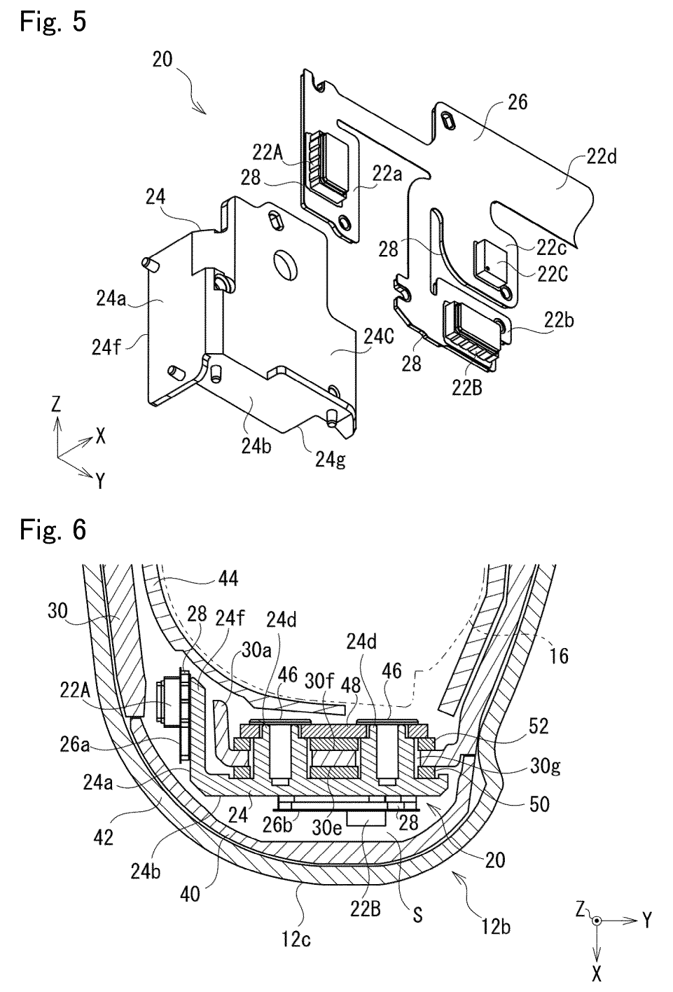

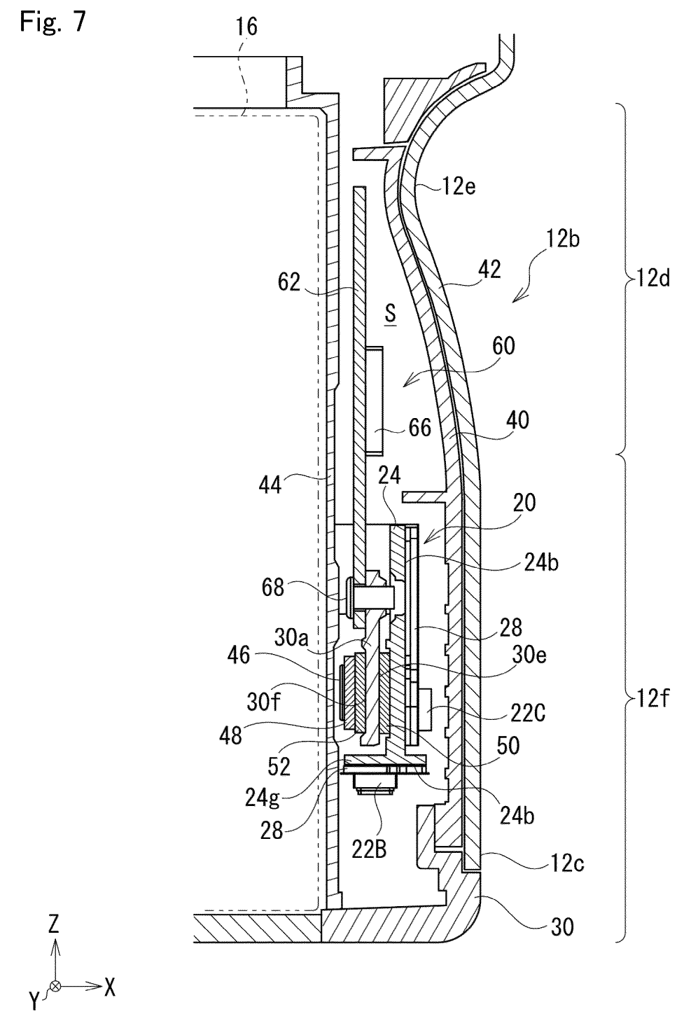

FIGS. 3 and 4 are a front perspective view and a rear perspective view of the sensor unit. FIG. 5 is an exploded perspective view of the sensor unit. Further, FIG. 6 is a cross-sectional view of the hand grip portion of the imaging device as viewed from above. FIG. 7 is a cross-sectional view of the hand grip portion of the imaging device as viewed from the left.

As illustrated in FIGS. 3 to 5, the sensor unit 20 is a gyro sensor unit for detecting inclination of the housing 12 of the imaging device 10, and detects changes in a pitch angle θp, a yaw angle θy, and a roll angle θr of the housing 12 as illustrated in FIG. 1. The pitch axis extends in the left-right direction (Y-axis direction) of the housing 12, the yaw axis extends in the height direction (Z-axis direction), and the roll axis extends in the front-rear direction (X-axis direction).

The pitch angle θp, the yaw angle θy, and the roll angle θr detected by the sensor unit 20 are used for "camera shake correction" for suppressing image blur.

To briefly describe "camera shake correction", first, image light of a subject transmitted through a lens (not illustrated) attached to the lens mount 14 is incident on an imaging element (not illustrated) in the housing 12 disposed behind the lens mount 14. When vibration is transmitted from the user's hand to the housing 12 of the imaging device 10, the imaging element in the imaging device 10 also vibrates. As a result, an image blur in which the outline of the subject appears blurred occurs in the captured image formed by the imaging element.

In order to suppress the occurrence of the image blur, the imaging device 10 includes an actuator (not illustrated) that slightly shifts the imaging element in a direction intersecting with an optical axis C of the imaging device 10 (left-right direction (Y-axis direction) and up-down direction (Z-axis direction)). A control device (for example, a processor such as a CPU) of the imaging device 10 calculates displacement amounts in the left-right direction and the height direction of the housing 12 on the basis of changes in the pitch angle θp, the yaw angle θy, and the roll angle θr detected by the sensor unit 20. Then, the control device controls the actuator so that the imaging element is shifted by a shift amount that offsets the calculated displacement amount. As a result, image blur is suppressed, and a captured image in which the outline of the subject is clearly shown is obtained.

As illustrated in FIGS. 3 to 5, in the case of the present embodiment, the sensor unit 20 includes a plurality of sensors 22A, 22B, and 22C, and a base member 24 that supports these sensors.

In the case of the present embodiment, each of the plurality of sensors 22A to 22C is a gyro sensor. The sensor 22A is a gyro sensor that detects the pitch angle θp, the sensor 22B is a gyro sensor that detects the yaw angle θy, and the sensor 22C is a gyro sensor that detects the roll angle θr. In the present embodiment, the sensors 22A and 22B are larger in size than the sensor 22C.

In the present embodiment, the plurality of sensors 22A to 22C are mounted on one flexible circuit board 26. Specifically, the flexible circuit board 26 includes a first portion 26a, a second portion 26b, and a third portion 26c on which the plurality of sensors 22A to 22C are mounted, and a connection portion 26d connected to the control device of the imaging device 10. In the present embodiment, a reinforcing plate 28 is attached to each of the first to third portions 26a to 26c.

The base member 24 is a member that supports the plurality of sensors 22A to 22C. In the case of the present embodiment, specifically, the base member 24 includes a first plane 24a to which the first portion 26a of the flexible circuit board 26 is attached, a second plane 24b to which the second portion 26b is attached, and a third plane 24c to which the third portion 26c is attached. The first to third planes 24a to 24c are formed in the base member 24 such that the respective normal lines cross each other.

As illustrated in FIGS. 6 and 7, the sensor unit 20 is disposed between the hand grip surface 12c of the housing 12 and the battery 16. Specifically, the base member 24 is disposed in the hand grip portion 12b of the housing 12 such that the first plane 24a of the base member 24 is orthogonal to the left-right direction (Y-axis direction) of the imaging device 10, the second plane 24b is orthogonal to the up-down direction (Z-axis direction), and the third plane 24c is orthogonal to the front-rear direction (X-axis direction).

The sensor unit 20 is disposed in the hand grip portion 12b by being attached to the housing 12.

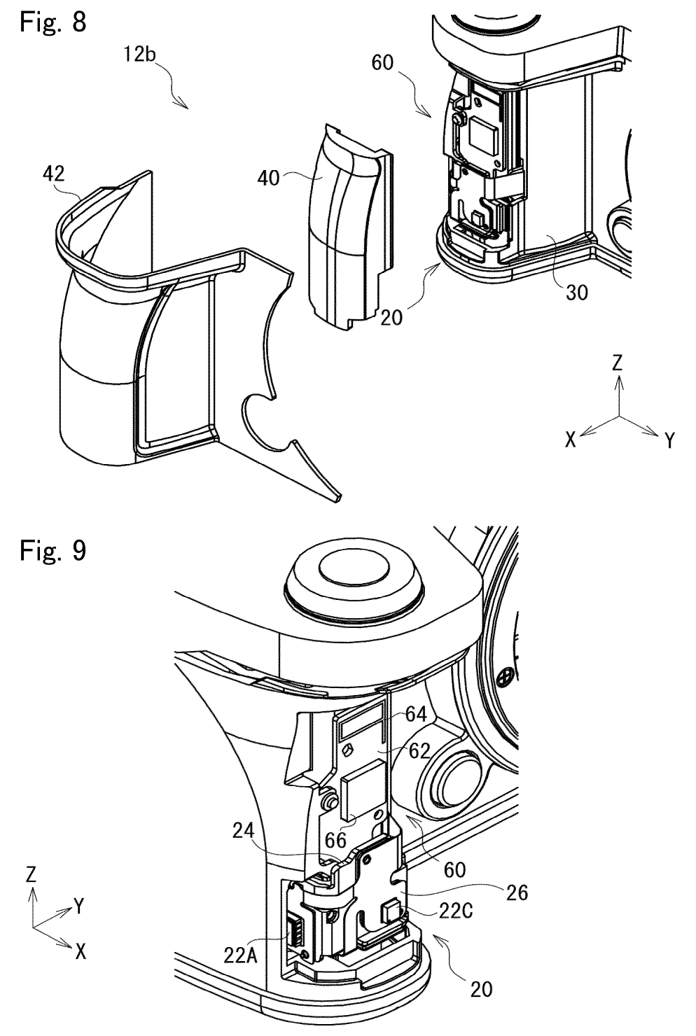

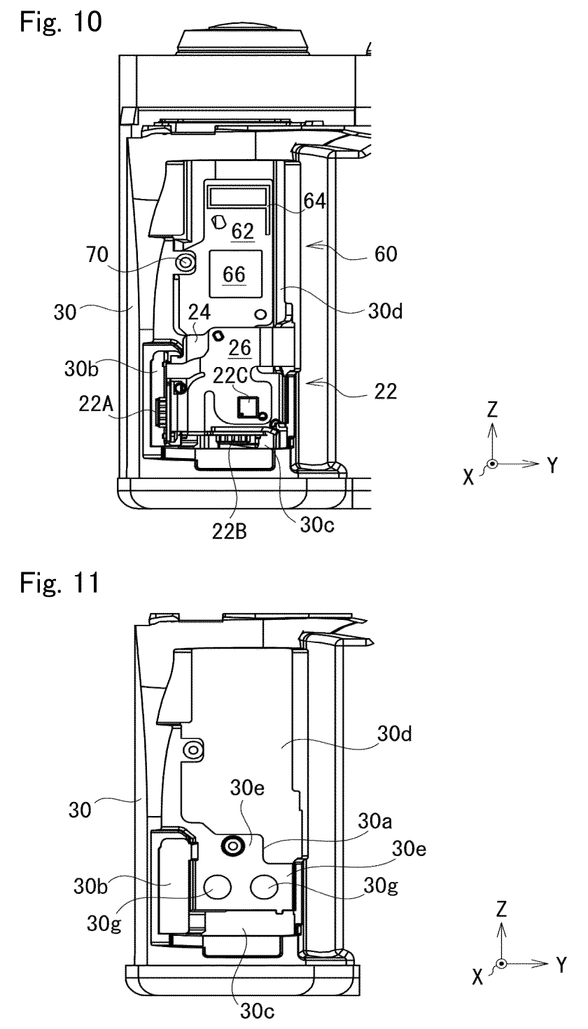

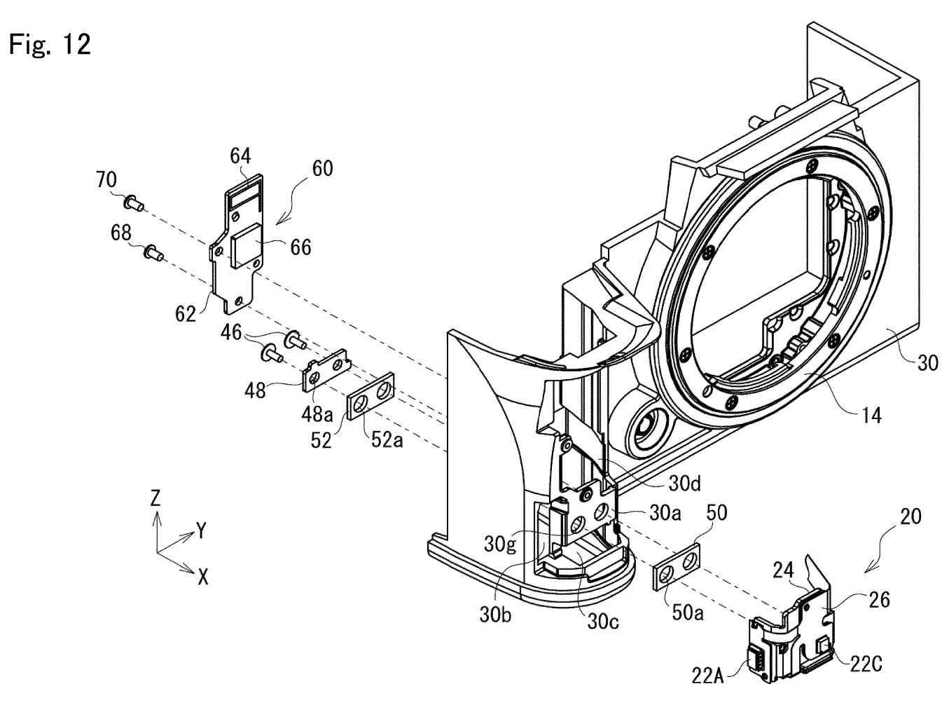

FIG. 8 is an exploded perspective view of a hand grip portion of the imaging device. FIGS. 9 and 10 are a perspective view and a front view of the sensor unit attached to the front case. FIG. 11 is a front view of a part of the front case. FIG. 12 is a perspective view illustrating attachment of the sensor unit to the front case.

As illustrated in FIGS. 1 and 2, the housing 12 of the imaging device 10 includes a front case 30, a top case 32, and a rear case 34. The front case 30 is a front side portion of the housing 12 including the front surface 12a of the housing 12 provided with the lens mount 14. In the case of the present embodiment, as shown in FIG. 8, the hand grip portion 12b of the housing 12 includes a part of the front case 30 and a cover member 40 attached to the front case 30. In the case of the present embodiment, a part of the front case 30 and the cover member 40 are covered with a hand grip cover 42 including the hand grip surface 12c. In the case of the present embodiment, the front case 30 is made of a metal material, and the cover member 40 is made of a resin material.

As shown in FIGS. 6 and 7, in the case of the present embodiment, the battery 16 is stored in a battery case 44 provided in the hand grip portion 12b of the housing 12. Therefore, in the case of the present embodiment, the sensor unit 20 is disposed between the battery case 44 and the cover member 40.

As illustrated in FIGS. 11 and 12, the front case 30 includes a sensor unit attachment portion 30a to which the sensor unit 20 is attached. In the case of the present embodiment, the sensor unit attachment portion 30a is surrounded by the plurality of through holes 30b, 30c, and 30d. The sensor unit attachment portion 30a is provided in the lower portion 12f of the hand grip portion 12b.

The sensor unit 20 is coupled to the sensor unit attachment portion 30a of the front case 30 in the front-rear direction (X-axis direction) of the imaging device 10 via a vibration control device.

Specifically, in the case of the present embodiment, as illustrated in FIG. 12, the vibration control device that couples the sensor unit 20 and the sensor unit attachment portion 30a of the front case 30 includes a plurality of fixing screws 46, a retainer member 48, a first vibration control member 50, and a second vibration control member 52.

Specifically, as illustrated in FIG. 12, the retainer member 48 is a plate-like member, and includes a plurality of through holes 48a through which the plurality of fixing screws 46 pass.

In addition, the retainer member 48 faces the base member 24 of the sensor unit 20 in the front-rear direction (X-axis direction) of the imaging device 10 across the sensor unit attachment portion 30a of the front case 30.

Specifically, as illustrated in FIGS. 6 and 7, the base member 24 of the sensor unit 20 is disposed to face a front surface 30e (first surface) of the sensor unit attachment portion 30a, and the retainer member 48 is disposed to face a rear surface 30f (second surface) of the sensor unit attachment portion 30a. Therefore, as illustrated in FIGS. 6 and 11, through holes 30g through which the plurality of fixing screws 46 pass are formed in the sensor unit attachment portion 30a of the front case 30. As illustrated in FIGS. 4 and 6, the base member 24 includes a plurality of boss portions 24d that protrude toward the rear side of the imaging device 10 and pass through the through holes 30g of the sensor unit attachment portions 30a of the front case 30. A female screw hole 24e to be engaged with the fixing screw 46 is formed at the tip of the boss portion 24d.

As illustrated in FIGS. 6, 7, and 12, the first vibration control member 50 of the vibration control device is disposed between the base member 24 and the front surface 30e of the sensor unit attachment portion 30a of the front case 30. The second vibration control member 52 is disposed between the rear surface 30f of the sensor unit attachment portion 30a and the retainer member 48.

The first and second vibration control members 50 and 52 are members that suppress vibrations other than vibrations transmitted from the user's hand to the housing 12 of the imaging device 10 from being transmitted to the sensor unit 20. The vibrations that are suppressed from being transmitted to the sensor unit 20 by the first and second vibration control members 50 and 52 are vibrations generated in the housing 12, for example, generated by an operation of a shutter or the like. These first and second vibration control members 50 and 52 enable the sensors 22A to 22C of the sensor unit 20 to accurately detect changes in the pitch angle θp, the yaw angle θy, and the roll angle θr of the housing 12 caused by vibrations transmitted from the user's hand to the housing 12 of the imaging device 10.

In the case of the present embodiment, for example, a viscoelastic member called SORBO (registered trademark) is used as the first and second vibration control members 50 and 52. The viscoelastic member is a plate-like member made of a viscoelastic material having both elastic and viscous properties. The viscoelastic material has a characteristic that the shape is deformed when an impact is applied and returns to the shape before the impact is applied over time. Therefore, the viscoelastic material is the same as the elastic material in that the shape is deformed when an impact is applied, but is different from the elastic material in that it takes time to restore. Due to the characteristics of the viscoelastic material, the viscoelastic member can absorb vibration. Instead of the viscoelastic member, the first and second vibration control members 50 and 52 may be, for example, sponges.

In addition, each of the first and second vibration control members 50 and 52 includes a plurality of through holes 50a and 52a through which the plurality of fixing screws 46 pass in the case of the present embodiment.

Therefore, in the case of the present embodiment, as illustrated in FIG. 6, the boss portion 24d of the base member 24 of the sensor unit 20 penetrates the first vibration control member 50, the sensor unit attachment portion 30a of the front case 30, and the second vibration control member 52. In this state, the base member 24 is fixed to the retainer member 48 via the plurality of fixing screws 46. That is, the fixing screw 46 sequentially penetrates the retainer member 48, the second vibration control member 52, the sensor unit attachment portion 30a, and the first vibration control member 50. As a result, the first vibration control member 50, the sensor unit attachment portion 30a, and the second vibration control member 52 are sandwiched between the base member 24 and the retainer member 48.

In the case of the present embodiment, as illustrated in FIGS. 6 to 10, a wireless communication unit 60 is disposed in addition to the sensor unit 20 between the battery 16 (specifically, the battery case 44) and the hand grip surface 12c (specifically, the cover member 40).

The wireless communication unit 60 is a unit for performing wireless communication with an external device, and includes a substrate 62, an antenna pattern 64 provided on the substrate 62, and a processor 66 that performs wireless communication using the antenna pattern 64.

As illustrated in FIG. 12, the substrate 62 of the wireless communication unit 60 is fixed to the front case 30 via fixing screws 68 and 70. In particular, as illustrated in FIG. 7, the substrate 62 is fixed to the rear surface 30f of the sensor unit attachment portion 30a of the front case 30 via the fixing screw 68.

As illustrated in FIG. 7, the substrate 62 of the wireless communication unit 60 extends upward from the sensor unit attachment portion 30a of the front case 30. Therefore, the wireless communication unit 60 is disposed in the upper portion of an internal space S of the hand grip portion 12b between the hand grip surface 12c (cover member 40) and the battery 16 (battery case 44). On the other hand, the sensor unit 20 is disposed in a lower portion of the internal space

S of the hand grip portion 12b. Specifically, a part of the wireless communication unit 60 is disposed behind the sensor unit 20, but is disposed within the range of the size of the sensor unit 20 in the front-rear direction (X-axis direction). With such a layout, an increase in size of the hand grip portion 12b (an increase in size of the imaging device 10 in the front-rear direction (X-axis direction)) is suppressed.

The wireless communication unit 60 thinner than the sensor unit 20 (smaller in size in the front-rear direction (X-axis direction) of the imaging device 10) is disposed in the upper portion of the internal space S of the hand grip portion 12b between the hand grip surface 12c (cover member 40) and the battery 16 (battery case 44). This is because, as shown in FIG. 7, a recessed portion 12e recessed rearward is provided in the upper portion 12d of the hand grip portion 12b, whereby the upper portion of the internal space S of the hand grip portion 12b is smaller than the lower portion. In contrast, when the sensor unit 20 is disposed in the upper portion of the internal space S, the hand grip portion 12b needs to be increased in size (increase in size in the front-rear direction (X-axis direction) of the imaging device 10).

With respect to suppression of an increase in size of the hand grip portion 12b, as shown in FIGS. 6 and 7, portions 24f and 24g of the base member 24 overlap the sensor unit attachment portion 30a as viewed in a direction (Y-axis direction, Z-axis direction) intersecting with a coupling direction (X-axis direction) between the base member 24 and the sensor unit attachment portion 30a of the front case 30. The term "overlap" as used herein refers to a state in which at least a part of one overlaps at least a part of the other when viewed from a certain direction. The portions 24f and 24g of the overlapping base member 24 extend rearward beyond the sensor unit attachment portion 30a. That is, the portions 24f and 24g pass through the through holes 30b and 30c of the front case 30 illustrated in FIG. 11. In addition, the sensors 22A and 22B having large sizes are provided in the portions 24f and 24g, respectively.

As described above, since the portions 24f and 24g of the base member 24 of the sensor unit 20 overlap the sensor unit attachment portion 30a of the front case 30, an installation space required for installing the sensor unit 20 and the sensor unit attachment portion 30a can be reduced. That is, in the case of not overlapping, the entire sensor unit 20 is positioned in front of the sensor unit attachment portion 30a, and as a result, the installation space of the sensor unit 20 and the sensor unit attachment portion 30a increases. Therefore, by reducing the installation space, the sensor unit 20 and the sensor unit attachment portion 30a can be disposed in the internal space S of the hand grip portion 12b without increasing the size of the hand grip portion 12b in the front-rear direction (X-axis direction) of the imaging device 10.

With respect to suppression of an increase in size of the hand grip portion 12b, in the case of the present embodiment, as illustrated in FIGS. 6 and 7, the portions 24f and 24g of the base member 24 of the sensor unit 20 overlap the vibration control device (that is, the fixing screw 46, the retainer member 48, and the first and second vibration control members 50 and 52) similarly to the sensor unit attachment portion 30a of the front case 30. With such an overlap, an installation space required for installing the sensor unit 20 and the vibration control device can be reduced. Therefore, the sensor unit 20 can be coupled to the sensor unit attachment portion 30a via the vibration control device in the internal space S of the hand grip portion 12b without increasing the size of the hand grip portion 12b in the front-rear direction (X-axis direction) of the imaging device 10.

Furthermore, in the case of the present embodiment, the sensors 22A and 22B having large sizes are provided in the portions 24f and 24g of the base member 24 overlapping the sensor unit attachment portion 30a and the vibration control device (that is, the fixing screw 46, the retainer member 48, and the first and second vibration control members 50 and 52). That is, the sensor 22C having a small size is provided on the second plane 24b of the base member 24 facing forward. As a result, as compared with the case where the large-sized sensors 22A and 22B are provided on the second plane 24b, the installation space of the sensor unit 20 is reduced with respect to the size in the front-rear direction (X-axis direction) of the imaging device 10. As a result, an increase in size of the hand grip portion 12b in the front-rear direction is suppressed.

Furthermore, in the case of the present embodiment, as illustrated in FIG. 6, the plurality of fixing screws 46 pass through the first and second vibration control members 50 and 52. As a result, the vibration control device (that is, the fixing screw 46, the retainer member 48, and the first and second vibration control members 50 and 52) is downsized in the left-right direction (Y-axis direction) of the imaging device 10. In contrast, when the plurality of fixing screws 46 are provided outside the first and second vibration control members 50 and 52 without penetrating therethrough, the retainer member 48 increases in size, and as a result, the vibration control device increases in size.

In addition, in the case of the present embodiment, as illustrated in FIG. 6, the portion 24f of the base member 24 of the sensor unit 20 overlaps the battery 16 (that is, the battery case 44) as viewed in the left-right direction (Y-axis direction) of the imaging device 10. Specifically, the front surface of the battery 16 (battery case 44) is a curved surface protruding forward as viewed in the up-down direction (Z-axis direction) of the imaging device 10, and thus, a substantially triangular space is formed between the front case 30 and the front surface of the battery 16 (battery case 44). The portion 24f of the base member 24 enters the triangular space. As a result, an increase in size of the hand grip portion 12b in the front-rear direction (X-axis direction) of the imaging device 10 is suppressed.

According to the present embodiment as described above, in the imaging device 10 in which the sensor unit 20 is mounted via the vibration control device (in the case of the present embodiment, the fixing screw 46, the retainer member 48, and the first and second vibration control members 50 and 52), the installation space for the sensor unit 20 and the vibration control device can be reduced.

In the case of the present embodiment, by reducing the installation space of the sensor unit 20 and the vibration control device, it is possible to suppress an increase in size of the hand grip portion 12b of the housing 12 of the imaging device 10. In addition, when the battery 16 is disposed in the hand grip portion 12b and an increase in size of the hand grip portion 12b cannot be realized due to restrictions such as design, it is possible to suppress the downsizing of the battery 16 by reducing the installation space of the sensor unit 20 and the vibration control device.

Although the embodiments of the present disclosure have been described above with reference to the above-described embodiments, the embodiments of the present disclosure are not limited thereto.

For example, in the case of the above-described embodiment, the vibration control device includes the fixing screw 46, the retainer member 48, and the first and second vibration control members 50 and 52. In addition, the sensor unit 20, the first vibration control member 50, the sensor unit attachment portion 30a of the front case 30, the second vibration control member 52, and the retainer member 48 are arranged in this order in the front-rear direction (X-axis direction) of the imaging device 10. Then, the sensor unit 20 is fixed to the retainer member 48 via the fixing screw 46. However, the embodiment of the present disclosure is not limited thereto.

For example, the sensor unit attachment portion of the front case, the first vibration control member, the sensor unit, the second vibration control member, and the retainer member may be sequentially arranged in one direction, and the retainer member may be fixed to the sensor unit attachment portion via a fixing screw. That is, in this case, the sensor unit is sandwiched between the sensor unit attachment portion and the retainer member via the first and second vibration control members.

In addition, in the case of the above-described embodiment, the sensor unit 20 is coupled to the sensor unit attachment portion 30a of the front case 30 in the front-rear direction (X-axis direction) of the imaging device 10 via the vibration control device (fixing screw 46, retainer member 48, first and second vibration control members 50 and 52). The sensor unit 20 is disposed in the hand grip portion 12b of the housing 12 of the imaging device 10. However, the embodiment of the present disclosure is not limited thereto. For example, the sensor unit may be provided at a position inside the housing other than the hand grip portion. Furthermore, the sensor unit and the sensor unit attachment portion of the front case may be coupled in a direction other than the front-rear direction of the imaging device 10.

Furthermore, in the case of the above-described embodiment, the sensors 22A to 22C of the sensor unit 20 are gyro sensors that detect changes in the pitch angle θp, the yaw angle θy, and the roll angle θr of the housing 12 of the imaging device 10, but the embodiment of the present disclosure is not limited thereto. The sensor of the sensor unit may be any sensor as long as the base member of the sensor unit needs to be attached to the front case via the vibration control device.

That is, in a broad sense, the imaging device according to the embodiment of the present disclosure is an imaging device including: a sensor unit; a front case that is a part of a housing and includes a sensor unit attachment portion; and a vibration control device that couples the sensor unit and the sensor unit attachment portion in a first direction, in which the sensor unit includes at least one sensor and a base member that supports the sensor, and a part of the base member overlaps the sensor unit attachment portion as viewed in a second direction intersecting the first direction.

As described above, the above-described embodiments have been described as examples of the technique in the present disclosure. To that end, the drawings and detailed description are provided. Therefore, the components described in the drawings and the detailed description may include not only components essential for solving the problem but also components that are not essential for solving the problem in order to illustrate the above-described technique. Therefore, it should not be immediately recognized that these non-essential components are essential based on the fact that these non-essential components are described in the drawings and the detailed description.

In addition, since the above-described embodiments are intended to illustrate the technique in the present disclosure, various changes, replacements, additions, omissions, and the like can be made within the scope of the claims or equivalents thereof.

The present disclosure is applicable to an imaging device in which a sensor unit including a sensor is mounted in a housing via a vibration control device.

What is claimed is:

1. An imaging device comprising:
a sensor unit;
a front case that is a part of a housing and includes a sensor unit attachment portion; and
a vibration control device that couples the sensor unit and the sensor unit attachment portion in a first direction, wherein
the sensor unit includes
at least one sensor, and
a base member that supports the sensor, and
a part of the base member overlaps the sensor unit attachment portion as viewed in a second direction intersecting the first direction.

2. The imaging device according to claim 1, wherein the part of the base member overlaps at least a part of the vibration control device as viewed in the second direction.

3. The imaging device according to claim 2, wherein
the vibration control device includes:
a first vibration control member disposed between the base member and a first surface of the sensor unit attachment portion;
a retainer member disposed at a distance from a second surface of the sensor unit attachment portion on an opposite side of the first surface in the first direction;
a second vibration control member disposed between the second surface of the sensor unit attachment portion and the retainer member; and
a fixing screw that fixes the base member to the retainer member in a state where the first and second vibration control members and the sensor unit attachment portion are sandwiched.

4. The imaging device according to claim 3, wherein the base member is fixed to the retainer member in a state where the fixing screw penetrates the sensor unit attachment portion and the first and second vibration control members.

5. The imaging device according to claim 1, wherein
the at least one sensor includes a plurality of sensors having different sizes, and
a sensor having a large size is provided in the part of the base member.

6. The imaging device according to claim 5, wherein the plurality of sensors are gyro sensors.

7. The imaging device according to claim 1, wherein
the first direction is a front-rear direction of the imaging device,
the imaging device further includes a battery,
the housing includes a hand grip portion having a hand grip surface gripped by a user,
the battery is disposed in the hand grip portion, and
the sensor unit attachment portion of the front case and the sensor unit are disposed in an internal space of the hand grip portion between the hand grip surface and the battery.

8. The imaging device according to claim 7, wherein
a front surface of the battery is a curved surface protruding forward as viewed in an up-down direction of the imaging device, and
the part of the base member overlaps the battery as viewed in a left-right direction of the imaging device.

9. The imaging device according to claim 7, further comprising a substrate, wherein
the substrate is disposed in the hand grip portion and attached to the sensor unit attachment portion.

10. The imaging device according to claim 9, wherein
a recessed portion is provided in an upper portion of the hand grip surface of the hand grip portion,
the sensor unit is disposed in a lower portion of the internal space of the hand grip portion, and
the substrate is disposed in an upper portion of the internal space in the hand grip portion.
